(19) United States
(12) Patent Application Publication
(10) Pub. No.: US 2005/0185147 A1
(43) Pub. Date: Aug. 25, 2005

(54) Method and apparatus to increase the color gamut produced by LCoS and other projection systems

(76) Inventor: Arthur Berman, San Jose, CA (US)

Correspondence Address: Reed Smith LLP, P.O. Box 7936, San Francisco, CA, 94120-7936, US

(21) Appl. No.: 10/783,156

(22) Filed: Feb. 20, 2004

(51) Int. Cl. G03B 21/14

(52) U.S. Cl. 353/84

(57) ABSTRACT

Liquid Crystal on Silicon (LCoS) microdisplays are individually illuminated with primary color light beams separated from an input light. The primary colors of the input light are sequentially changed and each microdisplay “displays,” or is otherwise energized to modulate the primary color light beam illuminating the microdisplay with image content. Each microdisplay's image content is “displayed” synchronously with, and is of a color corresponding to, the primary light beam illuminating the microdisplay. The modulated primary color light beams are recombined and output to a display. The primary colors of the input light alternate, for example, between either of RGB and YMC, and RGB and YCM. The alternating primary colors are, produced, for example, by a color wheel having sections of color transmissive filters.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to light management systems and particularly to projection systems. The invention is yet further related to LCoS based video projection systems and the use of additional alternating color channels in the projection system.

2. Discussion of Background

A conventional, three channel LCoS based video projection system is illustrated in FIG. 1. The light source 105 within the light engine is typically a mercury short arc lamp. The light produced by the light source is conditioned and shaped by a condenser 110 and input to kernel (prism assembly and microdisplays) 130 which separates the input light into light channels each of which are modulated by a corresponding microdisplay (e.g., 132A, 132B, and 132C). Once modulated, the light channels are re-combined to produce and output white light beam 150 containing an image composed of the individually modulated light channels. The output white light beam 150 is projected onto a display screen 160 (e.g., a display screen of a television or image projector).

### SUMMARY OF THE INVENTION

The present inventors have realized the need to increase the color gamut produced by modern projection systems. The present invention provides methods, techniques, and apparatuses to increase the color gamut produced by modern projection systems of a variety of configurations (e.g., an LCoS based video projection system). The color gamut is increased by adding additional primary colors to an image produced by the projection system. More specifically, in one embodiment, the present invention employs a quad type prism assembly having three microdisplays all operating in a color sequential mode in conjunction with color sequential illumination. In the above described embodiment, an image containing 6 primary colors can be produced. A variation of this system can produce an image with 5 primary colors while maintaining the highest possible blue light level (the present inventors have realized that maximizing blue light intensity is an important part of producing a bright image having a proper white point). However, the methods, techniques, and apparatuses disclosed herein may be applied to other prism assembly configurations and other projection systems.

In one embodiment, the present invention provides a sequencer, comprising, a light transmitting device configured to sequentially output a first light comprising a first set of primary colors and a second light comprising a second set of primary colors different from the first set of primary colors.

In one embodiment, the present invention is a system comprising, a set of light modulators, and drive electronics configured to drive the set of light modulators with subframes of a video image, wherein the subframes comprise a first subframe comprising a first set of primary colors and a second subframe comprising a second set of primary colors different from the first set of primary colors.

In another embodiment, the present invention is a projection device configured to display an image comprising at least two subframes, wherein each subframe comprises an independent set of primary colors.

In yet another embodiment, the present invention is an apparatus, comprising, a color sequencer configured to provide a sequence of color transmissive filters, wherein a size of a segment of each color transmissive filter in the sequence is proportional to an efficiency of a device to be used with the color sequencer.

In yet another embodiment, the present invention is a television, comprising, a display, and electronics configured to drive the display with image frames, each image frame comprising a first image subframe and a second image subframe, wherein, the first image subframe comprises an image in a first set of primary colors, and the second image subframe comprises an image in a second set of primary colors different from the first set of primary colors.

In another embodiment the present invention is an LCoS based television, comprising, a kernel, comprising a set of optical components comprising an input face, an output face, and a set of processing faces, a light source configured to direct light of alternating sets of primary colors to the input face, a set of reflective LCoS microdisplays, each reflective LCoS microdisplay individually located at one of the processing faces, a microdisplay driver configured to drive the set of microdisplays with a series of frames for a video image, a display screen, and a projection lens configured to project light modulated by the microdisplays from the output face onto the projection screen, wherein, each frame comprises a series of subframes each having an independent set of primary colors, and the microdisplay driver is configured to drive the microdisplays with a subframe comprising a set of primary colors synchronized with light comprising a matching set of primary colors directed to the input face by the light source.

In yet another embodiment, the present invention comprises a kernel configured to modulate light, a lighting device configured to provide input light to the kernel, and a projection lens configured to project modulated light output from the kernel, wherein, the kernel comprises, a set of light modulators, and optics configured to separate the input light into individual primary colored light beams, direct each primary colored light beam to a respective one of the modulators for modulation, and recombine the modulated primary colored light beams to produce the modulated light output from the kernel, and the lighting device is configured to provide the input light in a sequence that comprises light comprising a first set of primary colors and light comprising a second set of primary colors different from the first set of primary colors.

In another embodiment, the present invention is a device comprising, a color sequential illuminator configured to sequentially input at least two different sets of primary colors, a kernel comprising, n light modulators, and optics, a drive device configured to display a video image content on the microdisplays, wherein, the optics are configured to separate light from the color sequential illuminator into individual primary color light beams and respectively illuminate each of the n light modulators with one of the individual primary color light beams, the drive electronics are configured to respectively display individual primary color portions of the video image content respectively on each microdisplay synchronously with illumination of the microdisplay by a same color primary light beam such that a first primary color illuminates a first light modulator while displaying a first primary color portion of the image, and an nth primary color illuminates an nth light modulator while displaying an nth primary color portion of the image.

In another embodiment, the present invention is a method, comprising the steps of, providing an input light comprising a first set of n primary colors, dividing the first input light into a set of n primary color light beams, applying a first of the primary color light beams to a light modulator configured to modulate the first primary color light beam with image content of a same color as the first primary color light beam, applying a second of the primary color light beams to a light modulator configured to modulate the second primary color light beam with image content of a same color as the second primary color light beam, applying an nth of the primary color light beams to a light modulator configured to modulate the nth primary color light beam with image content of a same color as the nth primary color light beam, changing the input light such that it comprises a second set of primary colors, and repeating said steps of dividing and applying with respect to the changed input light.

Portions of both the device and method may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram of a conventional three channel LCoS based video projection system;

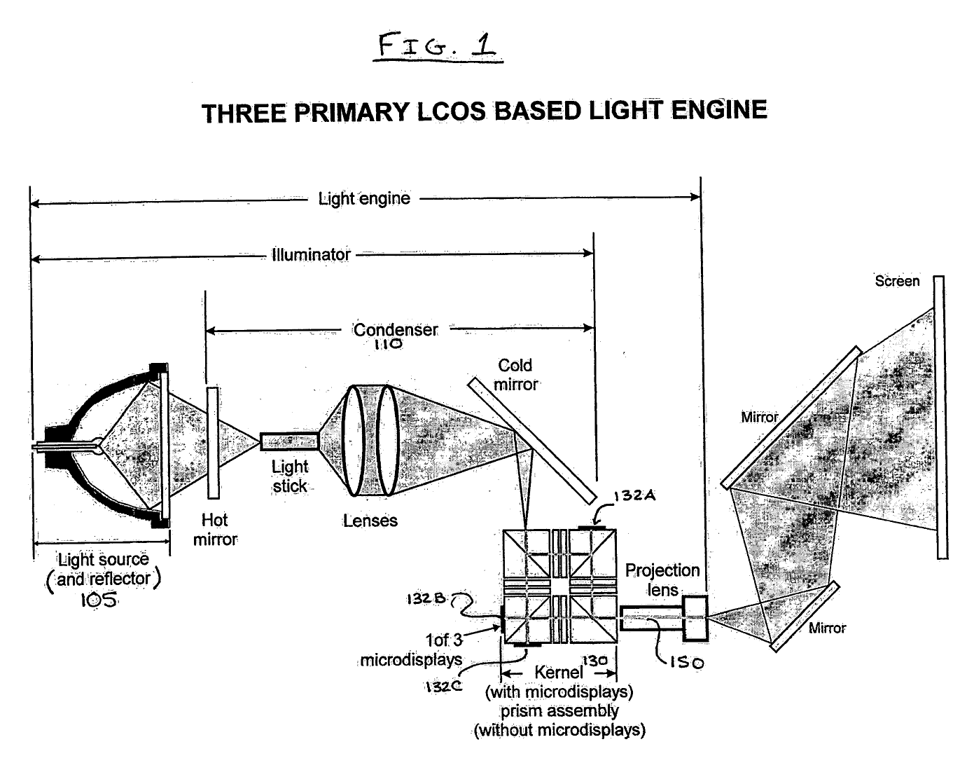

FIG. 2 is a graph of a spectrum of a mercury short arc lamp;

FIG. 3A is a diagram of a generalized version of one possible kernel configuration;

FIG. 3B is a graph of transmission spectra for a selection of components that may be utilized in the kernel configuration of FIG. 3A;

FIG. 3C is a graph of a color gamut produced by the kernel configuration of FIG. 3A when fitted with the component selection of FIG. 3B;

FIG. 4 is a graph of a generalized illustration of a color gamut corresponding to a four primary kernel configuration according to an embodiment of the present invention;

FIG. 5 is a diagram of a light engine according to an embodiment of the present invention;

FIG. 6 is a kernel fitted with a selection of components according to an embodiment of the present invention;

FIG. 7 is a graph of transmission spectra for a six primary kernel according to an embodiment of the present invention; and

FIG. 8 is a graph of transmission spectra for a five primary kernel according to an embodiment of the present invention.

### DESCRIPTION OF THE PREFERRED EMBODIMENTS

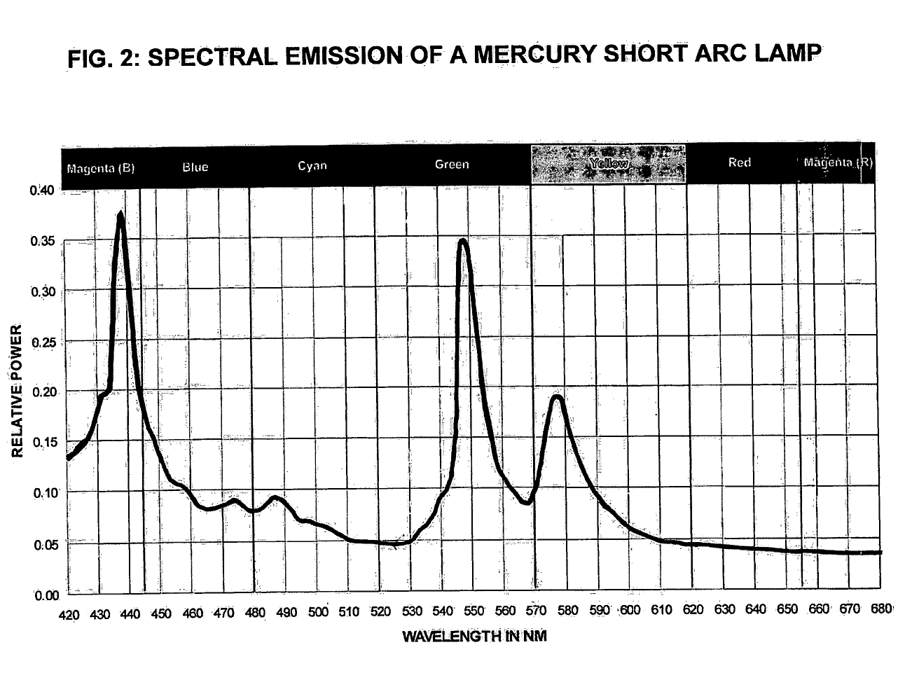

The spectrum of a mercury short arc lamp is illustrated in FIG. 2. For descriptive purposes within this document, portions of the spectrum have been assigned color names. Note that the combination of the extreme short and long wavelength portions of the spectrum form the color magenta. With this in mind, the extreme short wavelength end of the spectrum is called Magenta (B) indicating that this portion represents the blue portion of magenta. In the same way the extreme long wavelength end of the spectrum is called Magenta (R) indicating that this is the red portion of magenta.

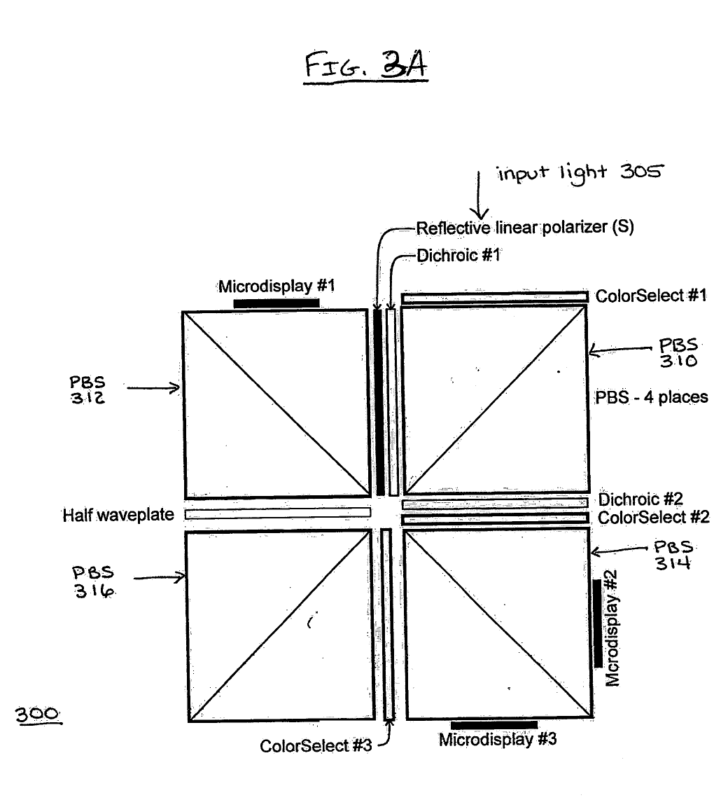

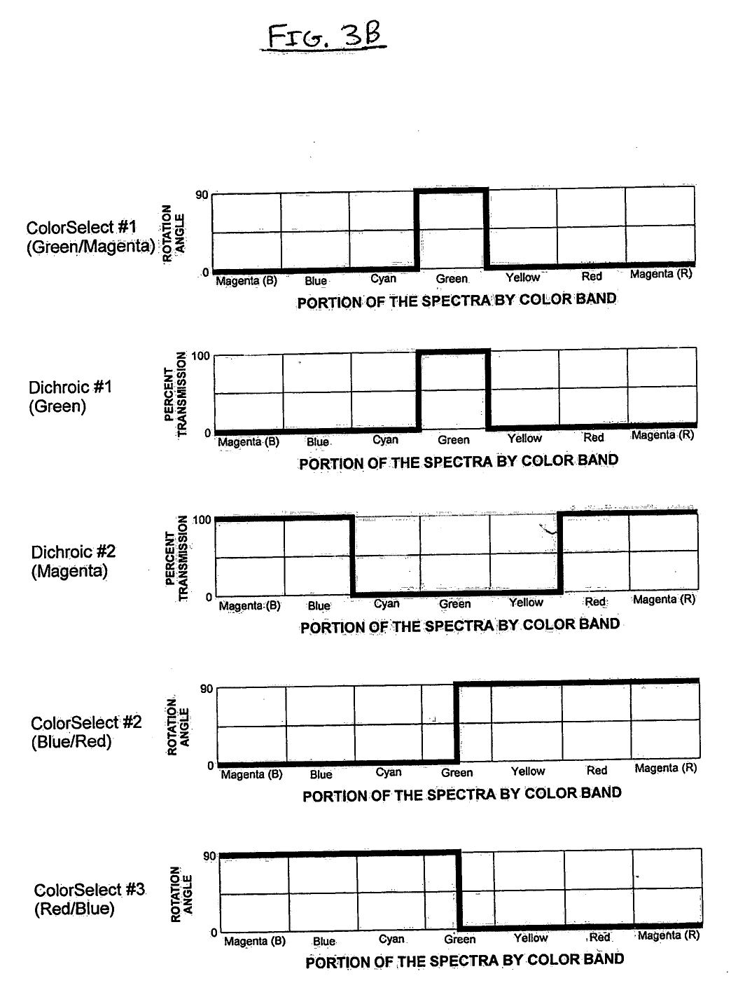

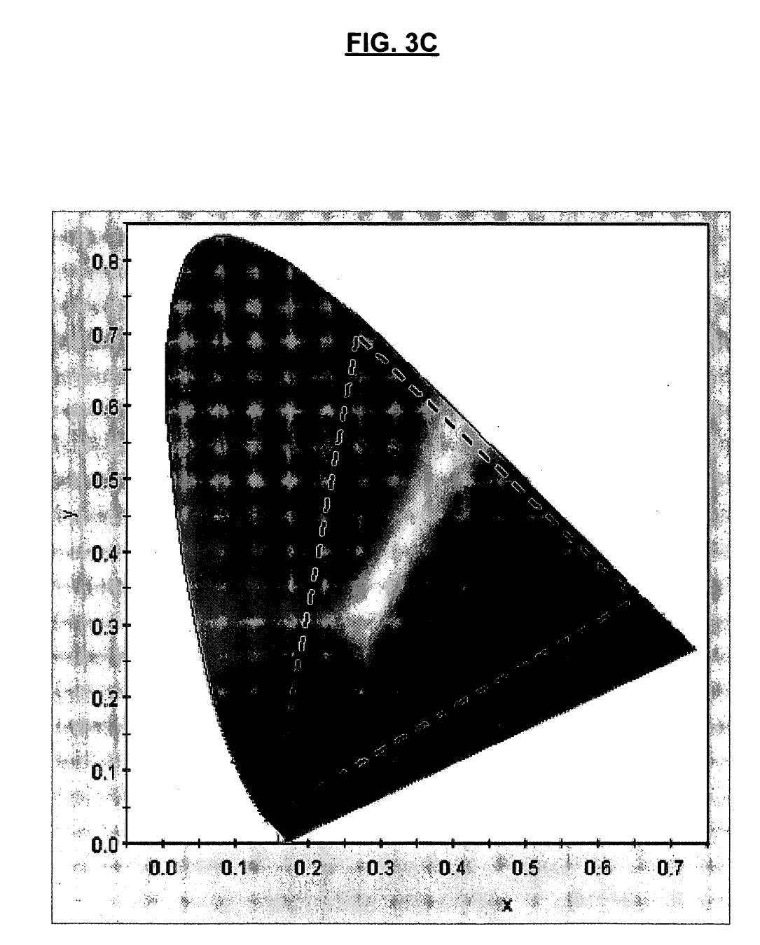

A generalized version of one possible kernel configuration (kernel 300), is illustrated in FIG. 3A. Details of optical elements used in one specific version of a kernel 350, following the placement of the optical elements in the kernel 300, are summarized in Table 1.

TABLE 1
Summary of Optical Element Details

| COMPONENT | DETAIL |
|---|---|
| Dichroic #1 | Green |
| Dichroic #2 | Magenta |
| ColorSelect #1 | Green / Magenta |
| ColorSelect #2 | Red / Blue |
| ColorSelect #3 | Blue / Red |
| Microdisplay #1 | Displays the green content of the full |
| | color video signal |
| Microdisplay #2 | Displays the red content of the full |
| | color video signal |
| Microdisplay #3 | Displays the blue content of the full |
| | color video signal |

The transmission/reflection spectra of the dichroic filters and wavelength responses of the ColorSelect waveplates and dichroics are illustrated in simplified form in FIG. 3B. The microdisplays (Microdisplay #1, Microdisplay #2, and Microdisplay #3) act in part as broadband reflectors and are, therefore, highly reflective across the entire visible spectrum. The transmission/reflection spectra of the dichroic filters (Dichroic #1 and Dichroic #2) and the wavelength response of the ColorSelect waveplates (ColorSelect #1, ColorSelect #2, and ColorSelect #3) are, along with the arrangement of polarizing beamsplitters (PBS 310, PBS 312, PBS 314, and PBS 316), designed so that red, green and blue portions of the spectrum (spectra) of light input (e.g., input light 305) into the kernel 300 are individually modulated by the microdisplays (e.g., red portion of the spectrum is modulated by the microdisplay that displays the red content of the full color video signal) and is ultimately displayed in a video image projected from the kernel 300.

Note that in the configuration with Table 1 components, yellow and cyan portions of the input light spectra are reflected back out of the kernel by the dichroics and do not appear in the projected image. The same effect can be accomplished by filtering the input light such that it contains only the red, green and blue portions of the spectrum. One benefit of rejecting these spectral portions is to produce a projected image in which the colors are more saturated. However, it is also desirable to produce a display system/image having the largest possible color gamut.

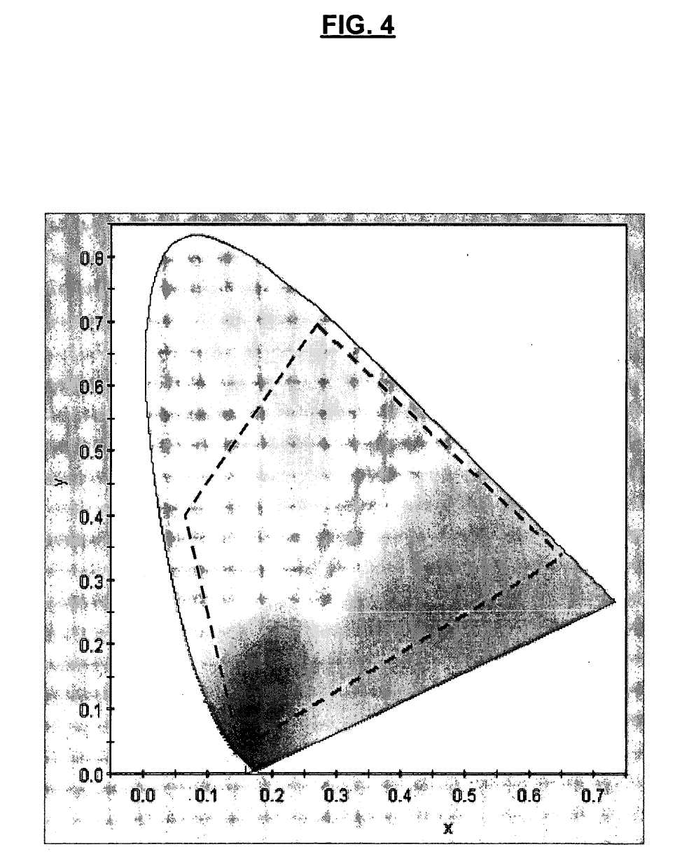

One means to increase the color gamut produced by a LCoS based, quad type kernel was discussed in previous disclosure Berman, U.S. Provisional Patent Application Ser. No. 60/508,707, attorney file no. 356508.02600, filed Oct. 3, 2003, and entitled “Four Color Channel Kernel,” the contents of which are incorporated herein by reference in its entirety. Some embodiments of the present invention include incorporation of a fourth microdisplay into a kernel to modulate an additional yellow or cyan primary. The addition of a fourth primary can increase the size of the color gamut along the lines illustrated in FIG. 4.

Another approach to increasing the color gamut of a LCoS based light engine is discussed by Roth et. al. in an article entitled “Wide Gamut, High Brightness Multiple Primaries Single Panel Projection Displays”. This article was published in Volume XXXIV, Book I, pages 118-121 of the 2003 International Symposium, Digest of Technical Papers of The Society For Information Display. The Roth approach utilizes a single microdisplay operating in the so called color sequential mode in which the display is sequentially illuminated with red, yellow, green, cyan, and blue light. The image presented on the display is sequentially the red, yellow, green, cyan and blue content of the video image. When the red light illuminates the microdisplay the red video content is displayed on the microdisplay and so on for the other colors.

The conventional means of producing color sequential illumination is to pass white light from the lamp through a color wheel. In one version of the color wheel, a series of windows containing transmissive color filters are located around the perimeter of a disk. The windows may be constructed in a variety of shapes (e.g., pie shaped, spiral, etc.). The first window transmits red light, the next green and the third blue. After passing through the color wheel, the light illuminates the microdisplay. The disk spins and, in this way, sequentially illuminates the microdisplay with red, green and then blue light. The microdisplay presents the red, green and blue content of the video image synchronously with the corresponding color illumination. The individual color images are projected in such rapid sequence that the human eye integrates the sub fields into a unified full color video image.

An alternative to a “mechanical” color wheel is an electronic color sequential shutter. Several such products are commercially available based on surface mode or ferroelectric liquid crystal electro optic effects.

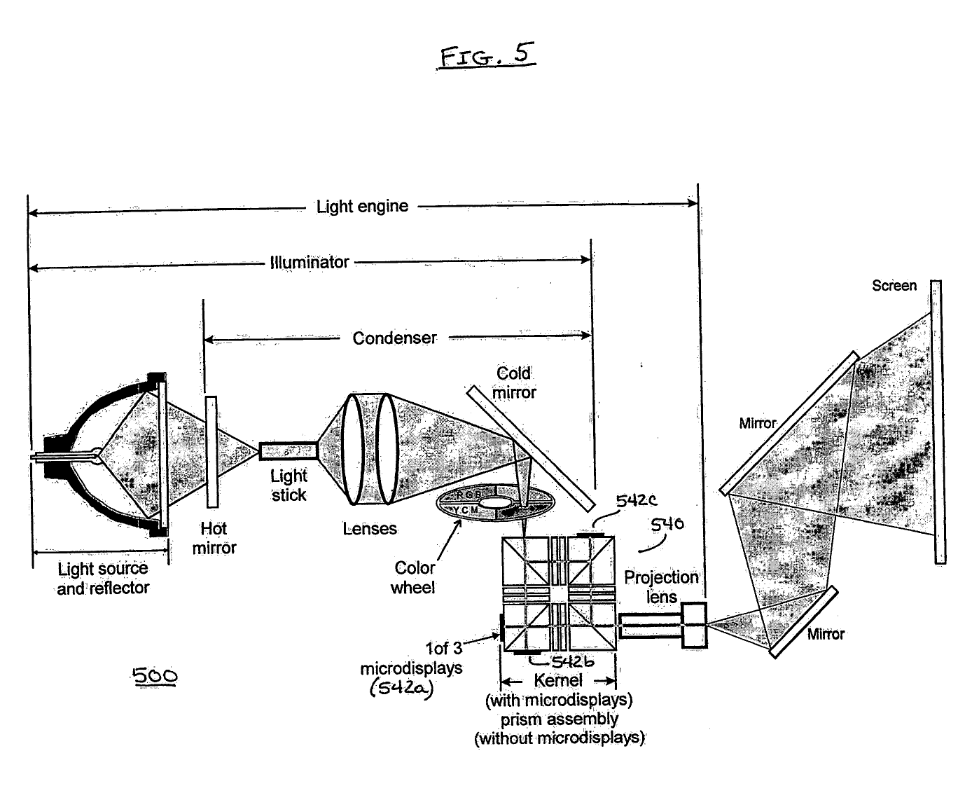

Referring again to the drawings, wherein like reference numerals designate identical or corresponding parts, and more particularly to FIG. 5 thereof, there is illustrated a generalized architecture of a light engine 500 according to an embodiment of the present invention. Note that the light engine 500 contains both a color wheel 510 and a three channel, quad type kernel 540. The principle of operation is that each full color video frame to be projected from the kernel 540 is divided into two subframes. During the first subframe microdisplays 542 (542a, 542b, and 542c) display the red/green/blue content of the video image. The color wheel is synchronized so as to pass light containing the red/green/blue portions of the visible spectrum during the first subframe.

During the second sub frame the microdisplays 542 display the yellow/cyan/magenta content of the video image. The color wheel 510 passes light containing the yellow/cyan/magenta portions of the visible spectrum during the second subframe. As in the conventional color sequential system, the human eye integrates the subframes into a full color image. However, the image is composed of 6 primary colors.

Details of optical elements identified and used in one specific embodiment of the kernel 540 are illustrated in Table 2. In this specific embodiment, the kernel 540 is constructed according to the kernel configuration illustrated in FIG. 3A with the optical elements of Table 2 inserted at the corresponding component locations. However, other kernel configurations may be modified to perform as a similar multi-sub-frame, multiple primary kernel.

TABLE 2
Details of the Materials in a Six Primary Kernel

| COMPONENT | DETAIL |
|---|---|
| Dichroic #1 | Green + Yellow |
| Dichroic #2 | Magenta + Cyan |
| ColorSelect | Green + Yellow / Magenta + Cyan |
| #1 | |
| ColorSelect | Red + Magenta / Blue + Cyan |
| #2 | |
| ColorSelect | Blue + Cyan / Red + Magenta |
| #3 | |
| Microdisplay | Sequentially displays the green and then the |
| #1 | yellow content of the full color video signal |
| Microdisplay | Sequentially displays the red and then magenta |
| #2 | content of the full color video signal |
| Microdisplay | Sequentially displays the blue and then cyan |
| #3 | content of the full color video signal |

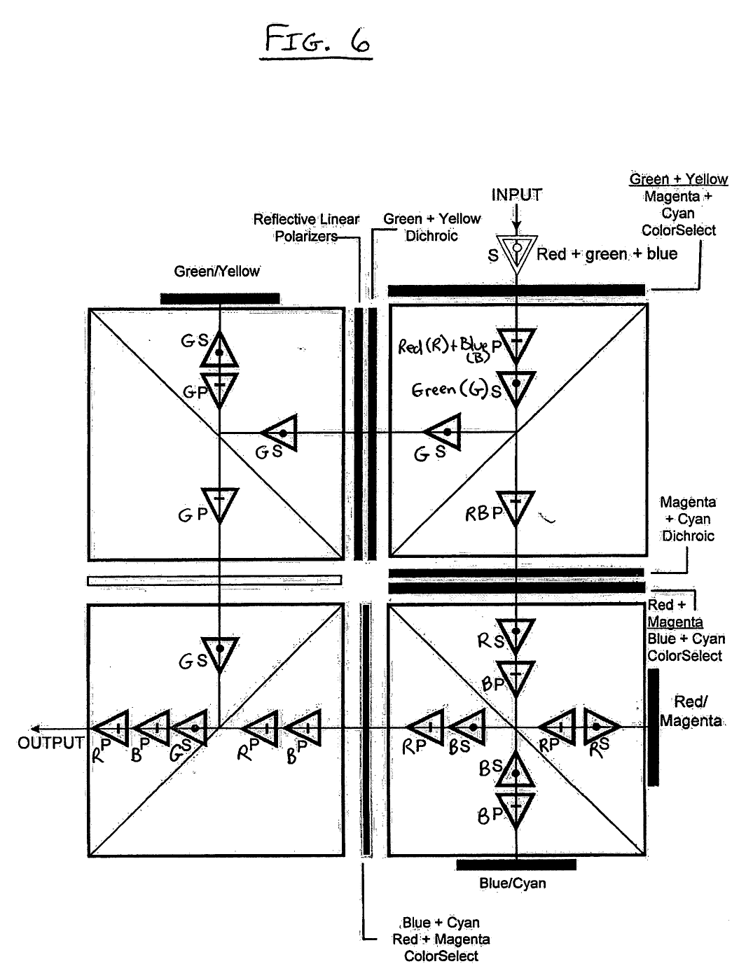

FIG. 6 illustrates details of the manipulation of input polarized light rays by the kernel 540 during the red, green, blue subframe sequence. The manipulation of light rays during the yellow, magenta, and cyan subframe sequence is similar except that yellow is substituted for green, magenta for red, and cyan for blue as described below.

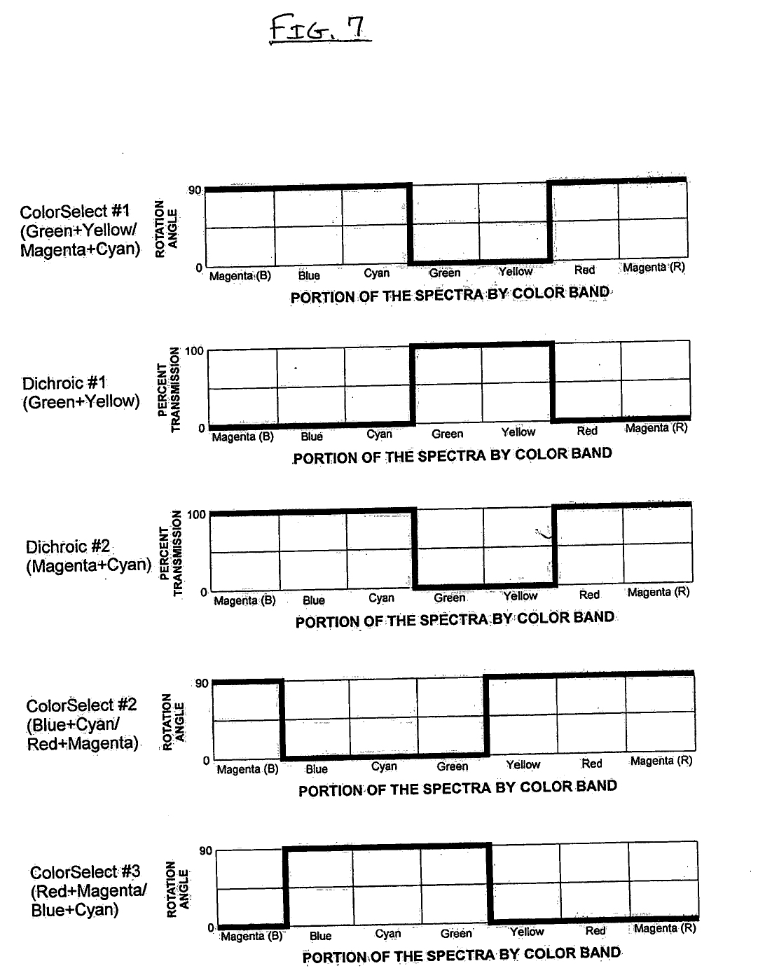

FIG. 7 illustrates example transmission spectra of the various optical materials within the above described specific embodiment of kernel 540. The kernel 540 manipulates the input light as illustrated in FIG. 6 and the primary colors that illuminate each microdisplay and the displays on each microdisplay change synchronously with each subframe. For example, during a first subframe, microdisplay #1 displays green content of the first subframe. The optics of the kernel (e.g., beamsplitters, dichroics, etc.) separate the green primary light from the input light into a green light beam and direct the green light beam to microdisplay #1 during the first subframe. Microdisplays #2 and #3 respectively display red and blue content of the first subframe while a primary red light beam and primary blue light beam are respectively directed to microdisplays #2 and #3 during the first subframe.

During a second subframe, microdisplays #1, #2, and #3 respectively display yellow, magenta, and cyan content of the second subframe while yellow, magenta, and cyan primary light beams are respectively directed to microdisplays #1, #2, and #3.

A projected image is well presented if it has a good white point. This is accomplished by “balancing” the intensities of the red, green and blue color content. As a practical matter, real projections systems are typically deficient in blue light content.

The present invention includes providing subframes that support “balanced” light output or balanced projected output from a kernel and light engine in a projection system. Balancing may be performed, for example, by reducing the red and green content in the image and/or increasing blue content. In one embodiment, such balancing may be performed by altering transmissivity of the filters providing the primary colored input light to the kernel. In one embodiment, the transmissivity of the filters is altered based on an efficiency of any of the kernel or other parts (alone or in combination) of the light engine. For example, if the overall optics of a light engine are deficient in blue light, the filters are selected so that a larger percentage of light passing the filters is blue to compensate for the blue deficiency. In the color wheel embodiments, such compensation may be performed by increasing the amount of blue light passed by the RGB section of the color wheel, or decreasing the amounts of green and red light passed, in proportion to the blue deficiency. In systems using a single microdisplay, compensation may be performed by increasing an area of blue transmissive filter on the color wheel.

In one embodiment, the present invention provides a sequence of subframes in which the first sub frame projects red, green and blue and a second sub frame that projects yellow, cyan and blue. In this case, a kernel configured to utilize the red, green, blue/yellow, cyan, blue subframe sequence would increase the blue content in the projected image while still adding two additional primaries.

The present invention includes a kernel configured to utilize subframe sequences that balance outputs of kernels and/or light engines. The details of a kernel 800 (not shown) is constructed according to the kernel configuration illustrated in FIG. 3A with the optical elements of Table 2 inserted at the corresponding component locations. The kernel 800 is configured to utilize the red, green, blue/yellow, cyan, blue subframe sequence are shown in Table 3.

TABLE 3
Details of the Materials in a Five Primary Kernel

| COMPONENT | DETAIL |
|---|---|
| Dichroic #1 | Green + Cyan |
| Dichroic #2 | Red + Yellow + Blue |
| ColorSelect #1 | Green + Cyan / Red + Yellow + Blue |
| ColorSelect #2 | Red + Yellow / Blue |
| ColorSelect #3 | Blue / Red + Yellow |
| Microdisplay | Sequentially displays the green and then the |
| #1 | cyan content of the full color video signal |
| Microdisplay | Sequentially displays the red and then yellow |
| #2 | content of the full color video signal |
| Microdisplay | Sequentially displays the blue and then same |
| #3 | blue content of the full color video signal |

The details correspond to components that may be substituted for the components illustrated in FIG. 3A. Again, kernel configurations other than the quad style kernel of FIG. 3A may be modified to take advantage of these same inventive concepts.

In the embodiment described by Table 3 (kernel 800) the illumination during the first sub frame is Red+Green+Blue. During the second sub-frame the illumination is Cyan+Yellow+Blue. Note that the light in the magenta (B) portion of the spectra is now combined with that in the blue of the second subframe, and the light in the magenta (R) is combined with that in the red of the first subframe.

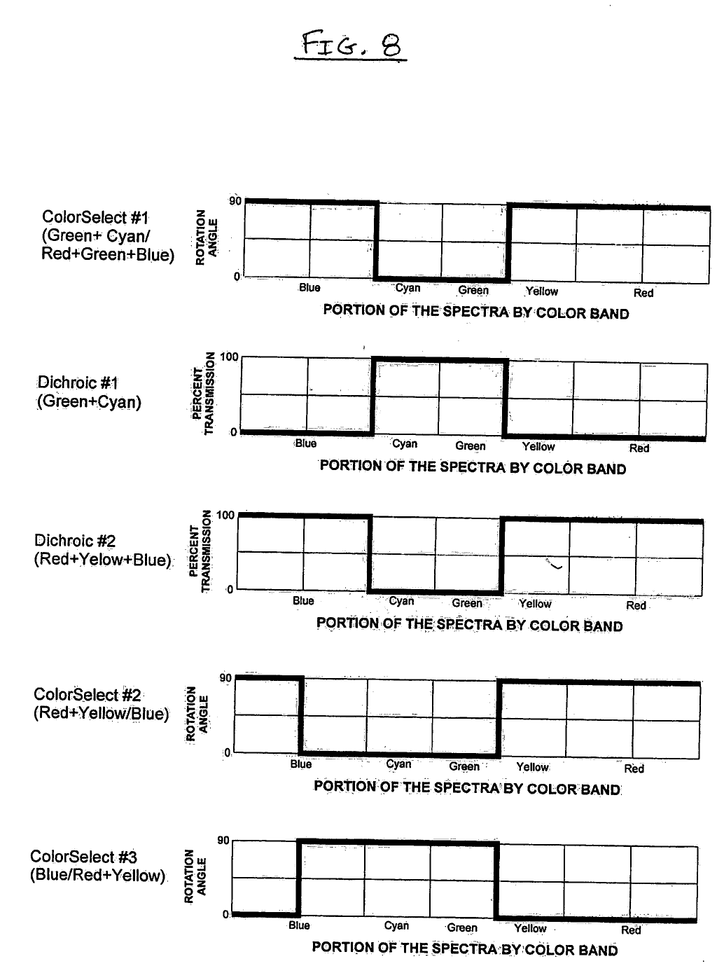

FIG. 8 illustrates the transmission spectra of the various optical materials within the kernel 800. The kernel 800 manipulates the input light in a means analogous to that illustrated in FIG. 6, except that the primary colors and displays on the microdisplays change synchronously with each subframe according to the red, green, blue/cyan, yellow, blue sequence of subframes.

Although the present invention has been described herein with reference to quad style kernels having mainly three reflective microdisplays, the devices and processes of the present invention may be applied to other kernel styles e.g., X prisms, or L shaped prisms. Also, the present invention may be re-configured to utilize transmissive LCD, or other light modulators instead of reflective microdisplays.

In describing preferred embodiments of the present invention, specific terminology has been employed for the sake of clarity. However, the present invention is not intended to be limited to the specific terminology so selected, and it is to be understood that each specific element includes all technical equivalents which operate in a similar manner. For example, when describing a red, green, blue/cyan, yellow, blue sequence of subframes, sequences may be substituted and not depart from the scope of the present invention. In addition when describing components such as dichroics, microdisplays, and beamsplitters other equivalent devices such as filters, light modulators, and mirrors or any other equivalent device having an equivalent function or capability, whether or not listed herein, may be substituted. Furthermore, the inventors recognize that newly developed technologies not now known may also be substituted for the described parts and still not depart from the scope of the present invention. All other described items, including, but not limited to color wheels, shutters, light engines, kernels, etc., should also be consider in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMS, EPROMS, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and hardware associated with any embodiment of the present invention. Such software may include, but is not limited to, device drivers, operating systems, and programs for determination and control of video frames and subframes. Ultimately, such computer readable media further includes software for performing the present invention, decomposing a video image into appropriate subframes.

Included in the programming (software) of the general/specialized computer or microprocessor are software modules for implementing the teachings of the present invention, including, but not limited to, production of frames and subframes, sequencing and/or timing of subframes, rotational speed of color wheels, activation of color shutters, etc., and synchronization of production of primary color light and displays of primary color portions of video subframes consistent with the teachings of the present invention.

The present invention may suitably comprise, consist of, or consist essentially of, any of element (e.g., color wheels, microdisplays, kernels, light sources, etc.), as described herein and their equivalents. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

1. A sequencer, comprising:
a light transmitting device configured to sequentially output a first light comprising a first set of primary colors and a second light comprising a second set of primary colors different from the first set of primary colors.

2. The sequencer according to claim 1, wherein the light transmitting device comprises a wheel having color transmissive filters configured to produce the first light and the second light.

3. The sequencer according to claim 1, wherein the light transmitting device comprises an electronic color sequential shutter.

4. The sequencer according to claim 3, wherein the electronic color sequential shutter comprises a shutter based on liquid crystal technology.

5. The sequencer according to claim 3, wherein the electronic color sequential shutter comprises a shutter based on surface mode technology.

6. The sequencer according to claim 1, wherein the light transmitting device comprises a wheel having an RGB color transmissive filter section and a YMC color transmissive section.

7. The sequencer according to claim 1, wherein the first set of primary colors and the second set of primary colors include blue.

8. The sequencer according to claim 1, wherein the first set of primary colors comprises RGB and the second set of primary colors comprises YCB.

9. A system, comprising:
a set of light modulators; and
drive electronics configured to drive the set of light modulators with subframes of a video image;
wherein the subframes comprise a first subframe comprising a first set of primary colors and a second subframe comprising a second set of primary colors different from the first set of primary colors.

10. The system according to claim 9, wherein the first set of primary colors comprises Red, Green, and Blue (RGB) primary colors and the second set of primary colors comprises Yellow, Magenta, and Cyan (YMC) primary colors.

11. The system according to claim 9, wherein the first set of primary colors comprises a blue primary color, and the second set of primary colors comprises a blue primary color.

12. The system according to claim 9, wherein the first set of primary colors comprises Red, Green, and Blue primary colors and the second set of primary colors comprises Cyan, Yellow, and Blue primary colors.

13. The system according to claim 9, wherein:
the drive electronics are configured to be synchronized with a lighting device that sequentially provides input light to the set of light modulators comprising the first set of primary colors and the second set of primary colors, such that the modulation devices are illuminated by light from the first set of primary colors when driven with the first subframe, and the modulation devices are illuminated by light from the second set of primary colors when driven with the second subframe.

14. The system according to claim 9, further comprising:
a kernel configured to separate input light into a set of individual primary color light beams and individually direct each primary color light beam to a corresponding one of the light modulators;
a lighting device configured to sequentially input light comprising the first set of primary colors and then light comprising the second set of primary colors to the kernel;
wherein:
the drive electronics are synchronized with the lighting device such that the modulation devices are illuminated by light from the first set of primary colors when driven with the first subframe, and the modulation devices are illuminated by light from the second set of primary colors when driven with the second subframe; and
the modulation devices are driven with each subframe such that each respective modulation device is driven by a color portion of each subframe corresponding to the primary color light beam directed to the respective modulation device.

15. The system according to claim 7, wherein the modulation devices comprise LCoS microdisplays.

16. A projection device configured to display an image comprising at least two subframes, wherein each subframe comprises an independent set of primary colors.

17. The projection device according to claim 1, wherein the at least two subframes comprise a first subframe comprising red, green, and blue primary colors, and a second subframe comprising yellow, magenta, and cyan primary colors.

18. The projection device according to claim 1, wherein the independent sets of primary colors are chosen from red, green, blue, yellow, magenta, and cyan.

19. The projection device according to claim 1, wherein at least two of the subframes include a blue primary color.

20. The projection device according to claim 1, wherein the at least two subframes comprise a first subframe comprising red, green, and blue primary colors, and a second subframe comprising yellow, cyan, and blue primary colors.

21. An apparatus, comprising:
a color sequencer configured to provide a sequence of color transmissive filters;
wherein a size of a segment of each color transmissive filter in the sequence is proportional to an efficiency of a device to be used with the color sequencer.

22. The apparatus according to claim 1, wherein the color sequence comprises at least one RGB segment and at least one YCM segment.

23. The apparatus according to claim 1, wherein the color sequence comprises at least one red segment, at least one blue segment, and at least one green segment.

24. The apparatus according to claim 3, wherein the color sequence further comprises at least one cyan segment.

25. The apparatus according to claim 3, wherein the color sequence further comprises at least one magenta segment.

26. The apparatus according to claim 1, wherein the color sequence comprises at least two segments containing blue.

27. The apparatus according to claim 1, further comprising:
a light source configured to direct light into the color sequencer; and
a kernel configured to receive and modulate color sequenced light from the color sequencer.

28. The apparatus according to claim 7, wherein the proportion of each segment of color sequenced light is proportional to both an amount of each color light from the light source and an efficiency of modulation performed by the kernel.

29. The apparatus according to claim 7, wherein the light modulator comprises a prism assembly and at least one light modulator.

30. The apparatus according to claim 9, wherein the light modulator comprises a microdisplay.

31. A television,
comprising:
a display; and
electronics configured to drive the display with image frames, each image frame comprising a first image subframe and a second image subframe;
wherein:
the first image subframe comprises an image in a first set of primary colors; and
the second image subframe comprises an image in a second set of primary colors different from the first set of primary colors.

32. The television according to claim 1, wherein the first set of primary colors comprises red, green and blue primary colors and the second set of primary colors comprises yellow, magenta, and cyan primary colors.

33. The television according to claim 1, wherein the first set of primary colors comprises red, green, blue and cyan yellow blue.

34. The television according to claim 1, wherein the first set of primary colors and the second set of primary colors both include blue.

35. The television according to claim 1 further comprising:
a light engine, comprising;
a kernel,
a light source configured to input light comprising a repeating sequence of the first set of primary colors and then the second set of primary colors to the kernel,
a set of light modulators configured to modulate light prior to output from the kernel, and
a lens configured to project modulated light output from the kernel to the display;
wherein the electronics drive the display by,
inputting content for the first image subframe to the light modulators in synchronicity with light of the first primary colors input to the kernel, and
inputting content for the second image subframe to the light modulators in synchronicity with light of the second primary colors input to the kernel.

36. An LCoS based television, comprising:
a kernel, comprising a set of optical components comprising an input face, an output face, and a set of processing faces;
a light source configured to direct light of alternating sets of primary colors to the input face;
a set of reflective LCoS microdisplays, each reflective LCoS microdisplay individually attached to one of the processing faces;
a microdisplay driver configured to drive the set of microdisplays with a series of frames for a video image;
a display screen; and
a projection lens configured to project light modulated by the microdisplays from the output face onto the projection screen;
wherein:
each frame comprises a series of subframes each having an independent set of primary colors; and
the microdisplay driver is configured to drive the microdisplays with a subframe comprising a set of primary colors synchronized with light comprising a matching set of primary colors directed to the input face by the light source.

37. A projector, comprising:
a kernel configured to modulate light;
a lighting device configured to provide input light to the kernel; and
a projection lens configured to project modulated light output from the kernel.
wherein:
the kernel comprises,
a set of light modulators, and
optics configured to separate the input light into individual primary colored light beams, direct each primary colored light beam to a respective one of the modulators for modulation, and recombine the modulated primary colored light beams to produce the modulated light output from the kernel; and
the lighting device is configured to provide the input light in a sequence that comprises light comprising a first set of primary colors and light comprising a second set of primary colors different from the first set of primary colors.

38. The projector according to claim 1, wherein the first set of primary colors comprises Red, Green, and Blue (RGB) primary colors and the second set of primary colors comprises Yellow, Magenta, and Cyan (YMC) primary colors.

39. The projector according to claim 1, wherein the first set of primary colors comprises a blue primary color, and the second set of primary colors comprises a blue primary color.

40. The projector according to claim 1, wherein the first set of primary colors comprises Red, Green, and Blue primary colors and the second set of primary colors comprises Cyan, Yellow, and Blue primary colors.

41. The projector according to claim 1, further comprising drive electronics configured to drive each respective light modulator with a color content corresponding to the primary colored light beam directed to the respective light modulator.

42. The projector according to claim 5, wherein the light modulators comprise reflective LCoS microdisplays.

43. The projector according to claim 1 wherein:
the lighting device comprises,
a light source, and
a color wheel configured to interact with light emanating from the light source to produce the input light provided to the kernel;
the projector further comprises drive electronics configured to drive the light modulators with subframes of an image to be displayed by the projector, the subframes comprising a subframe of the first primary color set and a subframe of the second primary color set; and
the drive electronics and color wheel are synchronized such that the light modulators are driven with subframes of the first primary color set while primary colored light beams from the first primary color set are directed at the light modulators and subframes of the second primary color set while primary colored light beams from the second primary color set are directed at the light modulators

44. The projector according to claim 7, wherein the color wheel comprises Red, Green, and Blue primary color section and a Cyan, Yellow, and Blue primary color section.

45. The projector according to claim 7, wherein the color wheel comprises a Red, Green, and Blue (RGB) primary color section and a Yellow, Magenta, and Cyan (YMC) primary color section.

46. The projector according to claim 7, wherein the first set of primary colors comprises a blue primary color, and the second set of primary colors comprises a blue primary color.

47. The projector according to claim 1 wherein:
the lighting device comprises,
a light source, and
a electronic color sequential shutter configured to interact with light emanating from the light source to produce the input light provided to the kernel;
the projector further comprises drive electronics configured to drive the light modulators with subframes of an image to be displayed by the projector, the subframes comprising a subframe of the first primary color set and a subframe of the second primary color set; and
the drive electronics and electronic color sequential shutter are synchronized such that the light modulators are driven with subframes of the first primary color set while primary colored light beams from the first primary color set are directed at the light modulators and subframes of the second primary color set while primary colored light beams from the second primary color set are directed at the light modulators.

48. The projector according to claim 11, wherein the first set of primary colors comprises a blue primary color, and the second set of primary colors comprises a blue primary color.

49. A device comprising:
a color sequential illuminator configured to sequentially input at least two different sets of primary colors;
a kernel comprising,
n light modulators, and
optics;
a drive device configured to display a video image content on the microdisplays;
wherein;
the optics are configured to separate light from the color sequential illuminator into individual primary color light beams and respectively illuminate each of the n light modulators with one of the individual primary color light beams;
the drive electronics are configured to respectively display individual primary color portions of the video image content respectively on each microdisplay synchronously with illumination of the microdisplay by a same color primary light beam such that a first primary color illuminates a first light modulator while displaying a first primary color portion of the image, and an nth primary color illuminates an nth light modulator while displaying an nth primary color portion of the image.

50. A method, comprising the steps of:
providing an input light comprising a first set of n primary colors;
dividing the first input light into a set of n primary color light beams;
applying a first of the primary color light beams to a light modulator configured to modulate the first primary color light beam with image content of a same color as the first primary color light beam;
applying a second of the primary color light beams to a light modulator configured to modulate the second primary color light beam with image content of a same color as the second primary color light beam;
applying an nth of the primary color light beams to a light modulator configured to modulate the nth primary color light beam with image content of a same color as the nth primary color light beam;
changing the input light such that it comprises a second set of primary colors; and
repeating said steps of dividing and applying with respect to the changed input light.

51. A kernel configured to utilize 6 primary light channels in a color sequential mode.

52. The kernel according to claim 1, wherein the color sequential mode comprises sequentially illuminating the kernel with alternating sets of primary colors; and the kernel further comprises a set of optical elements configured to operate on each set of primary colors.

53. The kernel according to claim 1, further comprising an input light path and a Green+Yellow/Magenta+Cyan ColorSelect type waveplate in the input path.

54. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel; and
a Green+Yellow/Magenta+Cyan ColorSelect waveplate positioned in an input light channel of the kernel.

55. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel; and
a Green+Yellow dichroic positioned between the input beamsplitter and the first processing beamsplitter.

56. The kernel according to claim 1, wherein the kernel is a quad style kernel comprising
an input beamsplitter and an output beamsplitter on a first diagonal of the kernel;
a first processing beamsplitter and a second processing beamsplitter on a second diagonal of the kernel; and
a Magenta+Cyan dichroic positioned between the input beamsplitter and the second processing beamsplitter.

57. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel; and
a Red+Magenta/Blue+Cyan ColorSelect waveplate positioned between the input beamsplitter and the second processing beamsplitter.

58. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel;
a Magenta+Cyan dichroic positioned between the input beamsplitter and the second processing beamsplitter; and
a Red+Magenta/Blue+Cyan ColorSelect waveplate positioned between the input beamsplitter and the second processing beamsplitter.

59. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel; and
a Blue+Cyan/Red+Magenta ColorSelect waveplate between the second processing beamsplitter and the output beamsplitter.

60. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel;
a Green+Yellow/Magenta+Cyan ColorSelect type optical element positioned in an input light channel of the kernel;
a Magenta+Cyan dichroic type optical element positioned between the input beamsplitter and the second processing beamsplitter;
a Red+Magenta/Blue+Cyan ColorSelect type optical element positioned between the input beamsplitter and the second processing beamsplitter; and
a Blue+Cyan/Red+Magenta ColorSelect type optical element positioned between the second processing beamsplitter and the output beamsplitter.

61. A kernel configured to utilize 5 primary light channels in a color sequential mode.

62. The kernel according to claim 1, wherein the color sequential mode comprises sequentially illuminating the kernel with alternating sets of primary colors; and the kernel further comprises a set of optical elements configured to operate on each set of primary colors.

63. The kernel according to claim 2, wherein the alternating sets of primary colors each comprise 3 primary colors, and each set of primary colors have a blue primary color.

64. The kernel according to claim 1, further comprising an input light path and a Green+Cyan/Red+Yellow+Blue ColorSelect type waveplate in the input path.

65. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel; and
a Green+Cyan/Red+Yellow+Blue ColorSelect waveplate positioned in an input light channel of the kernel.

66. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel; and
a Green+Cyan dichroic positioned between the input beamsplitter and the first processing beamsplitter.

67. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel; and
a Red+Yellow+Blue dichroic positioned between the input beamsplitter and the second processing beamsplitter.

68. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel; and
a Red+Yellow/Blue ColorSelect waveplate positioned between the input beamsplitter and the second processing beamsplitter.

69. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel;
a Red+Yellow+Blue dichroic positioned between the input beamsplitter and the second processing beamsplitter; and
a Red+Yellow/Blue ColorSelect waveplate positioned between the input beamsplitter and the second processing beamsplitter.

70. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel; and
a Blue/Red+Yellow ColorSelect waveplate positioned between the second processing beamsplitter and the output beamsplitter.

71. The kernel according to claim 1, wherein the kernel is a quad style kernel comprising,
an input beamsplitter and an output beamsplitter on a first diagonal of the kernel;
a first processing beamsplitter and a second processing beamsplitter on a second diagonal of the kernel;
a Green+Cyan/Red+Yellow+Blue ColorSelect waveplate positioned in an input light channel of the kernel;
a Red+Yellow+Blue dichroic positioned between the input beamsplitter and the second processing beamsplitter; and
a Red+Yellow/Blue ColorSelect waveplate positioned between the input beamsplitter and the second processing beamsplitter; and
a Blue/Red+Yellow ColorSelect waveplate positioned between the second processing beamsplitter and the output beamsplitter.
